(19) United States
(12) Patent Application Publication
(10) Pub. No.: US 2018/0074205 A1
(43) Pub. Date: Mar. 15, 2018

(54) DETECTION OF OUTLIER RANGE MEASUREMENTS USING SPATIAL DISPLACEMENT DATA

(71) Applicant: QUALCOMM Incorporated, San Diego, CA (US)

(72) Inventors: Urs Niesen, Summit, NJ (US); Lionel Jacques Garin, Palo Alto, CA (US); Jubin Jose, Belle Mead, NJ (US)

(21) Appl. No.: 15/265,617

(22) Filed: Sep. 14, 2016

(51) Int. Cl. G01S 19/22; G01S 19/26; G01S 19/29

(52) U.S. Cl. CPC G01S 19/22; G01S 19/29; G01S 19/26

(57) ABSTRACT

The disclosure generally relates to position sensors, and more particularly to outlier detection using spatial displacement data. An apparatus for use in position sensing may include a displacement sensor, a positioning signal receiver having a receiver clock, a memory, and a processor coupled to the displacement sensor, the positioning signal receiver, and the memory. The processor and memory may be configured to calculate a change in a receiver clock bias of the receiver clock based on range measurements and spatial-based displacement data, propagate a first range measurement based, at least in part, on the spatial-based displacement data and the change in the receiver clock bias, and determine an outlier range measurement based, at least in part, on the propagated first range measurement.

### FIELD OF DISCLOSURE

Various embodiments described herein generally relate to position sensors, and more particularly to detection of outlier range measurements using spatial displacement data.

### BACKGROUND

Communications networks offer increasingly sophisticated capabilities associated with the motion and/or position location sensing of a mobile device. New software applications, such as, for example, those related to personal productivity, collaborative communications, social networking, and/or data acquisition, may utilize motion and/or position sensors to provide new features and services to consumers. Moreover, some regulatory requirements of various jurisdictions may require a network operator to report the location of a mobile device when the mobile device places a call to an emergency service, such as a “911” call in the United States.

Such motion and/or position determination capabilities have conventionally been provided using Satellite Positioning Systems (SPS). SPS wireless technologies which may include, for example, the Global Positioning System (GPS) and/or a Global Navigation Satellite System (GNSS). A mobile device supporting SPS may obtain positioning signals as wireless transmissions received from one or more satellites equipped with transmitting devices. The positioning signal may be used by the mobile device to estimate geographic position and heading. Some mobile devices may additionally or alternatively obtain positioning signals as wireless transmissions received from terrestrial based transmitters to estimate geographic position and heading and/or include one or more inertial sensors (e.g., accelerometers, gyroscopes, compasses, etc.) to measure an inertial state of the mobile device. Inertial measurements obtained from these inertial sensors may be used in combination with SPS signals to provide estimates of geographic position and heading.

However, conventional methods for combining inertial measurements and SPS signals have thus far been insufficient to effectively reduce error or location uncertainty. Accordingly, new techniques are needed for improving the speed and accuracy of position sensing.

### SUMMARY

The following summary is an overview provided solely to aid in the description of various aspects of the disclosure and is provided solely for illustration of the aspects and not limitation thereof.

In one example, an apparatus for use in position sensing is disclosed. The apparatus may include, for example, a displacement sensor configured to generate spatial-based displacement data, a positioning signal receiver comprising a receiver clock and configured to receive positioning signals from a transmitting device over a period of time and estimate range measurements to the transmitting device based on the positioning signals, memory, and a processor coupled to the displacement sensor, the positioning signal receiver, and the memory, wherein processor and memory are configured to: calculate a change in a receiver clock bias of the receiver clock based on the range measurements and the spatial-based displacement data corresponding to the period of time, propagate a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time, and determine an outlier range measurement based, at least in part, on the propagated first range measurement and a second range measurement corresponding to the second portion of the period of time.

In another example, a method for use in position sensing is disclosed. The method may include, for example, generating spatial-based displacement data, receiving positioning signals from a transmitting device over a period of time and estimating range measurements to the transmitting device based on the positioning signals, calculating a change in a receiver clock bias of a receiver clock based on the range measurements and the spatial-based displacement data corresponding to the period of time, propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time, and determining an outlier range measurement based, at least in part, on the propagated first range measurement and a second range measurement corresponding to the second portion of the period of time.

In another example, another apparatus for use in position sensing is disclosed. The apparatus may include, for example, means for generating spatial-based displacement data, means for receiving positioning signals from a transmitting device over a period of time and estimating range measurements to the transmitting device based on the positioning signals, means for calculating a change in a receiver clock bias of a receiver clock based on the range measurements and the spatial-based displacement data corresponding to the period of time, means for propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time, and means for determining an outlier range measurement based, at least in part, on the propagated first range measurement and a second range measurement corresponding to the second portion of the period of time.

In another example, a non-transitory computer-readable medium including code, which, when executed by a processor, causes the processor to perform operations is disclosed. The computer-readable medium may include, for example, code for generating spatial-based displacement data, code for receiving positioning signals from a transmitting device over a period of time and estimating range measurements to the transmitting device based on the positioning signals, code for calculating a change in a receiver clock bias of a receiver clock based on the range measurements and the spatial-based displacement data corresponding to the period of time, code for propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time, and code for determining an outlier range measurement based, at least in part, on the propagated first range measurement and a second range measurement corresponding to the second portion of the period of time.

### BRIEF DESCRIPTION OF THE DRAWINGS

The accompanying drawings are presented to aid in the description of various aspects of the disclosure and are provided solely for illustration of the aspects and not limitation thereof.

FIG. 1 generally illustrates a position sensing environment in accordance with aspects of the disclosure.

FIG. 2 generally illustrates a mobile device having conventional position sensing capabilities.

FIG. 3 generally illustrates a positioning signal receiver having conventional position sensing capabilities.

FIG. 4 generally illustrates a mobile device in accordance with aspects of the disclosure.

FIG. 5 generally illustrates a method for use in position sensing in accordance with aspects of the disclosure.

FIG. 6 generally illustrates a method for calculating a change in a receiver clock bias of a receiver clock in accordance with aspects of the disclosure.

FIG. 7 generally illustrates a method for propagating range measurements in accordance with aspects of the disclosure.

FIG. 8 generally illustrates a method for determining an outlier range measurement in accordance with aspects of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration”. Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

The terminology used herein is for the purpose of describing particular embodiments only and not to limit any embodiments disclosed herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. Similarly, the phrase “based on” as used herein does not necessarily preclude influence of other factors and should be interpreted in all cases as “based at least in part on” rather than, for example, “based solely on” or “based only on”.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

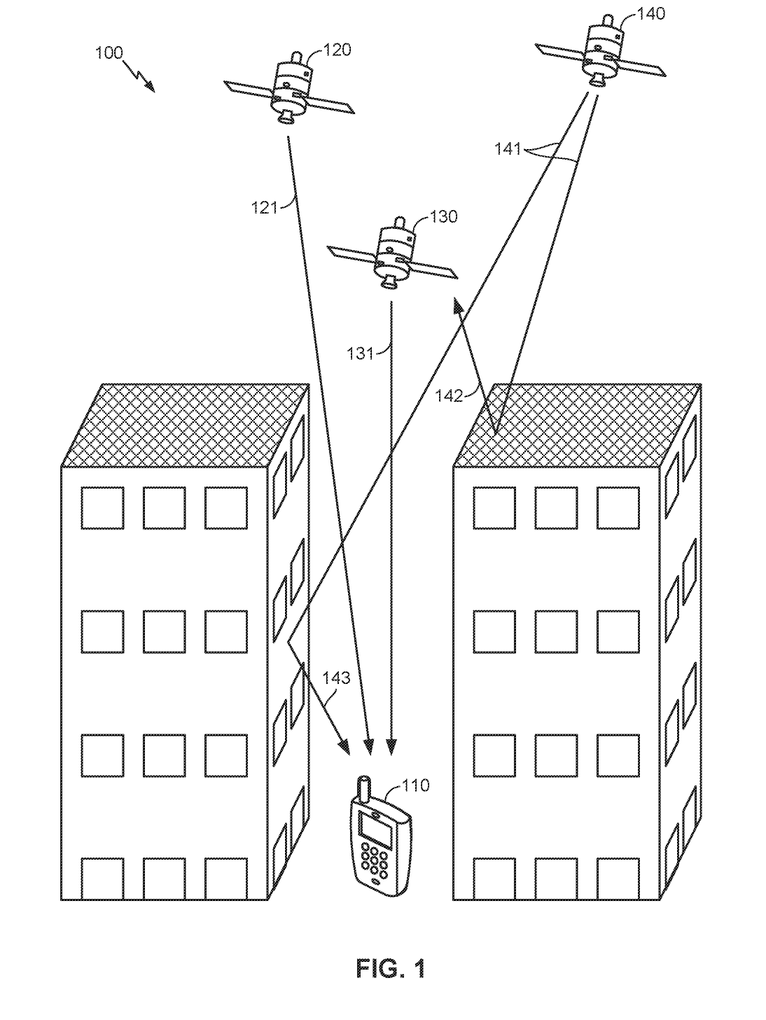

FIG. 1 generally illustrates a position sensing environment 100 in accordance with aspects of the disclosure. The position sensing environment 100 may include a mobile device 110. The mobile device 110 may be configured to determine a position of the mobile device 110 based, at least in part, on positioning signals received within the position sensing environment 100. Although the mobile device 110 is depicted as a mobile telephone, it will be understood that the mobile device 110 may be a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, a device in a automotive vehicle, and/or any other device with a need for position sensing capability.

As depicted in FIG. 1, the position sensing environment 100 includes a plurality of transmitting devices 120, 130, 140. The transmitting device 120 may transmit a positioning signal 121, the transmitting device 130 may transmit a positioning signal 131, and the transmitting device 140 may transmit a positioning signal 141. In the position sensing environment 100 depicted in FIG. 1, each of the transmitting devices 120, 130, 140 may be associated with a particular satellite vehicle, and the plurality of satellite vehicles may be part of a satellite positioning system (SPS). However, it will be understood that the mobile device 110 may be configured to receive positioning signals analogous to the positioning signals 121, 131, 141 from any suitable signal source.

In a SPS, a system of transmitting devices (depicted as transmitting devices 120, 130, 140) enable devices such as the mobile device 110 to sense a position on or above the earth based, at least in part, on signals received from transmitting devices analogous to the transmitting devices 120, 130, 140. The transmitting devices 120, 130, 140 may transmit a signal that includes a code, for example, a repeating pseudo-random noise (PRN) code. The transmitting devices 120, 130, 140 may be located on ground-based control stations, user equipment and/or space vehicles. In some implementations, the transmitting devices 120, 130, 140 may be located on Earth-orbiting satellite vehicles (SVs). For example, a SV in a constellation of a Global Navigation Satellite System (GNSS) such as Global Positioning System (GPS), Galileo, Glonass or Compass may transmit a signal marked with a particular code that is distinguishable from codes transmitted by other SVs in the constellation (e.g., using different codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other positioning signals associated with such one or more SPS.

The position sensing environment 100 depicted in FIG. 1 shows an example of a particular scenario in which conventional methods for determining position based on positioning signals (for example, positioning signals associated with an SPS) have thus far been insufficient to satisfactorily reduce error or location uncertainty. Consider, for example, a scenario in which the mobile device 110 must receive each of the plurality of positioning signals 121, 131, 141 in order to quickly and accurately determine the position of the mobile device 110. In the scenario depicted in FIG. 1, which may be referred to as an “urban canyon” scenario, tall structures block one or more of the positioning signals 121, 131, 141 necessary to quickly and accurately determine the position of the mobile device 110. For example, the positioning signal 121 may facilitate position sensing because there is a direct line of sight between the mobile device 110 and the transmitting device 120. Likewise, the positioning signal 131 may facilitate position sensing because there is a direct line of sight between the mobile device 110 and the transmitting device 130. However, because there are intervening structures, the positioning signal 141 may not facilitate position sensing by the mobile device 110.

FIG. 1 depicts two intervening structures, both of which are depicted as tall buildings. However, it will be understood that any intervening structure, natural or man-made, may affect transmission of the positioning signals 121, 131, 141. In this scenario, the positioning signal 141 is blocked by one or more intervening structures, resulting in a blocked positioning signal 142. Because the positioning signal 141 never reaches the mobile device 110, it may not facilitate position sensing. In some scenarios, the mobile device 110 may have previously acquired and tracked the positioning signal 141, and relied on it to sense position. Because the positioning signal 141 is now blocked, the positioning signal 141 is lost. The mobile device 110 may need to replace or re-acquire the positioning signal 141 before the position of the mobile device 110 can be accurately sensed.

Additionally or alternatively, the positioning signal 141 may be reflected off the one or more intervening structures, resulting in a reflected positioning signal 143. Because the positioning signal 141 reaches the mobile device 110 indirectly, it may not facilitate position sensing. As will be discussed in greater detail below, the mobile device 110 may sense position based on estimated times of flight (TOF) associated with the positioning signals 121, 131, 141. Because the positioning signal 141 is reflected and received as the reflected positioning signal 143, the path of the positioning signal 141 is lengthened. Accordingly, the TOF estimated by the mobile device 110 may also be lengthened. As a result, the reflected positioning signal 143 received by the mobile device 110 may cause an inaccurate estimation of the distance between the transmitting device 140 and the mobile device 110. The position sensing capability of the 110 may therefore be degraded.

It will be understood that in some scenarios, for example, urban canyon scenarios, a direct line of sight to the transmitting devices 120, 130, 140 may not be reliably obtained. Accordingly, new techniques are required for position determination.

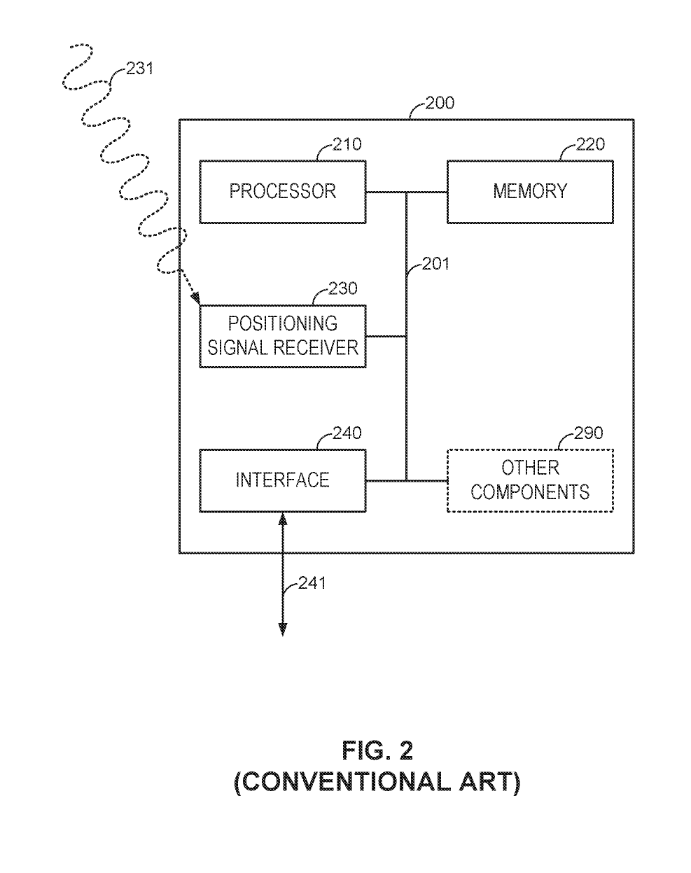

FIG. 2 generally illustrates a mobile device 200 having conventional position sensing capabilities.

The mobile device 200 depicted in FIG. 2 includes a processor 210, a memory 220, a positioning signal receiver 230, and an interface 240. The mobile device 200 may optionally include other components 290.

The processor 210 may include one or more microprocessors, microcontrollers, and/or digital signal processors that provide processing functions, as well as other calculation and control functionality. The memory 220 may be configured to store data and/or instructions for executing programmed functionality within the mobile device 200. The memory 220 may include on-board memory that is, for example, in a same integrated circuit package as the processor 210. Additionally or alternatively, memory 220 may be external to the processor 210 and functionally coupled over the common bus 201.

The positioning signal receiver 230 may be configured to receive one or more positioning signals 231 from a transmitting device, for example, a transmitting device analogous to the transmitting devices 120, 130, 140 depicted in FIG. 1. The positioning signal receiver 230 may be further configured to estimate range measurements based on the one or more positioning signals 231. The range measurements estimated by the positioning signal receiver 230 may indicate a distance between the mobile device 200 and the particular transmitting device from which a particular positioning signal of the one or more positioning signals 231 was received. The positioning signal receiver 230 may be configured to receive the one or more positioning signals 231 using, for example, one or more antennas, one or more filters, one or more demodulators, a receiver clock, and/or any other suitable hardware.

The positioning signal receiver 230 may further comprise any suitable hardware and/or software for receiving, processing, and/or storing the received positioning signals. In some implementations, the positioning signal receiver 230 may comprise a processor and a memory that are analogous in some respects to the processor 210 and the memory 220 described above.

The interface 240 may be used to provide interface data 241 of the mobile device 200 to an external entity. For example, the interface 240 may comprise a user interface and the interface data 241 may include audio output, visual output, tactile output, or any other output suitable for a user of the mobile device 200 (for example, a screen, a speaker, etc.). Additionally or alternatively, the interface data 241 may include audio input, visual input, tactile input, or any other suitable input from a user of the mobile device 200 (for example, from a microphone, a touch screen, a keyboard, a button, etc.). Additionally or alternatively, the interface 240 may comprise an electrical coupling and the interface data 241 may include one or more signals (for example, a sensed position of the mobile device 200) to another device (for example, an external user interface, a vehicle, etc.). Additionally or alternatively, the interface 240 may comprise a transceiver and the interface data 241 may include one or more transmitted signals (for example, a sensed position of the mobile device 200).

The other components 290 may include, for example, wide area network transceivers, local area network transceivers, or any other components suitable for inclusion in a mobile device such as the mobile device 200. It will be understood that the mobile device 200 may be a music player, a video player, an entertainment unit, a navigation device, a communications device, a mobile device, a mobile phone, a smartphone, a personal digital assistant, a fixed location terminal, a tablet computer, a computer, a wearable device, an Internet of things (IoT) device, a laptop computer, a server, a device in a automotive vehicle, and/or any other device with a need for position sensing capability. As such, the mobile device 200 may include any number of other components 290.

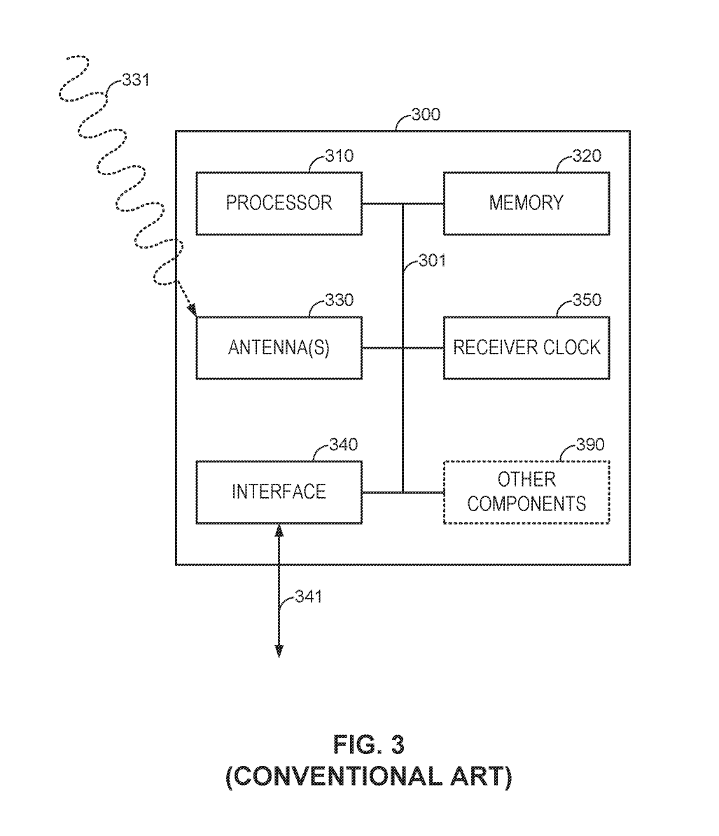

FIG. 3 generally illustrates a positioning signal receiver 300 having conventional position sensing capabilities. The positioning signal receiver 300 may be analogous to, for example, the positioning signal receiver 230 depicted in FIG. 2. Accordingly, the positioning signal receiver 300 may be incorporated into a mobile device analogous to, for example, the mobile device 200 depicted in FIG. 2. The positioning signal receiver 300 may comprise a processor 310, a memory 320, an antenna 330, an interface 340, a receiver clock 350, and other components 390.

The processor 310 and the memory 320 may be analogous in some respects to the processor 210 and the memory 220 described above. The processor 310 and/or memory 320 may be configured to process and/or store the signals received by the antenna 330. The processor 310 and/or memory 320 may be further configured to generate position data 341 indicating a position of the positioning signal receiver 300. The position data 341 may be provided by the processor 310 and/or memory 320 to the interface 340. The interface 340 may be used to provide the position data 341 to an external entity, for example, the common bus 201 of the mobile device 200.

The antenna 330 may be configured to receive one or more positioning signals 331. In some implementations, the antenna 330 may include a plurality of antennas, for example, one or more main antennas and/or one or more reference antennas. However, for simplicity of illustration, the one or more antennas included in the positioning signal receiver 300 will be referred to in the singular as the antenna 330. The one or more positioning signals 331 may be analogous to the positioning signals 121, 131, 141 depicted in FIG. 1 and may be received from transmitting devices analogous to the transmitting devices 120, 130, 140 depicted in FIG. 1. The antenna 330 may be configured to receive the one or more positioning signals 331 continuously over a period of time.

In some implementations, the one or more positioning signals 331 may include a pseudo-random noise (PRN) code. Each transmitting device may be associated with a unique and/or specific code. The memory 320 may store a plurality of replica codes and the identity and/or position of a specific transmitting device to which each of the replica codes corresponds. For example, “CODE₁₂₀” may correspond to the transmitting device 120, “CODE₁₃₀” may correspond to the transmitting device 130, “CODE₁₄₀” may correspond to the transmitting device 140, etc. If, for example, the positioning signal 121 is received at the antenna 330, then the positioning signal 121 may include the “CODE₁₂₀” identifying the transmitting device 120. To recognize the CODE₁₂₀, the positioning signal receiver 300 may correlate the received positioning signal 121 with one or more of the replica codes CODE₁₂₀, CODE₁₃₀, CODE₁₄₀, etc. The positioning signal receiver 300 may be configured to determine, based on the correlating, that the positioning signal 121 includes the CODE₁₂₀, and was therefore received from the transmitting device 120. Moreover, the timing of the correlating may be used to estimate the distance from the transmitting device 120 to the positioning signal receiver 300, as will be discussed in greater detail below.

The receiver clock 350 may be configured to keep time. The receiver clock 350 may be synchronized with a transmitter clock incorporated into the transmitting device 120. In some implementations, each of the transmitting devices 120, 130, 140 may be equipped with a high-precision transmitter clock, for example, an atomic clock. The transmitter clocks in each of the transmitting devices 120, 130, 140 may be synchronized. In some implementations, the receiver clock 350 may be less precise than an atomic clock, and the lack of precision associated with the receiver clock 350 may be referred to as receiver clock bias.

The start time t_{T} for the transmission of a particular code may be predetermined and known to, for example, the positioning signal receiver 300. Moreover, the receiver clock 350 may be configured to determine a time t_{R} at which a particular code, for example, the CODE₁₂₀, is received. Accordingly, the delay t_{TOF} caused by the time of flight of the positioning signal 121 from the transmitting device 120 to the antenna 330 may be determined based on the predetermined transmission time t_{T} and the receiving time t_{R}. In particular, the delay t_{TOF} may be equal to t_{R}−t_{T}.

For example, “CODE₁₂₀” may have a 1.00 ms duration and may be transmitted at 1.00 ms intervals beginning at a transmission start time t₀. Accordingly, “CODE₁₂₀” will be transmitted at a plurality of transmitting times t_{T}, wherein t_{T}=t₀+N*(1.00 ms), N being an integer. As noted above, the transmission start time t₀ may be scheduled or predetermined such that it is known in advance by both the transmitting device 120 and the positioning signal receiver 300.

The positioning signal 121 may travel from the transmitting device to the antenna 330 at the speed of light and may reach the antenna 330 after a delay t_{TOF} caused by the time of flight. For example, suppose that CODE₁₂₀ is transmitted at a predetermined transmitting time t_{T}=1.00 ms, and that the receiver clock 350 determines that the code is received at receiving time t_{R}=1.20 ms. The positioning signal receiver 300 may therefore conclude that the delay t_{TOF} is equal to 0.20 ms. Because the speed of light is ˜300 km/ms, a delay t_{TOF} equal to 0.20 ms would indicate a distance of ˜60 km. The estimated distance may be referred to as a “range estimate”, a “pseudorange”, and/or a “code-phase measurement”. It will be understood that this is a simplified description of how the positioning signal receiver 300 estimates a code-phase measurement, and that other factors affecting the estimating of the code-phase measurement have been omitted for brevity.

As noted above, each transmitting device may be associated with a different PRN code. Accordingly, the positioning signal receiver 300 may perform a plurality of code-phase measurements based on a plurality of the one or more positioning signals 331, each code-phase measurement corresponding to a different transmitting device. After, for example, three or more code-phase measurements are performed, the position of the positioning signal receiver 300 can be calculated using triangulation based on the known positions of the three or more corresponding transmitting devices. In some implementations, code-phase measurements may be used to sense a position of the positioning signal receiver 300 with precision on the order of several meters.

The positioning signal receiver 300 can achieve greater precision using carrier-phase measurements. As noted above, each of the one or more positioning signals 331 may include a repeating PRN code used for generating code-phase measurements. However, the code cycle may have a first frequency and may be carried on a carrier wave having a second frequency that is significantly greater than the first frequency. Because the frequency of the carrier wave is greater than the frequency of the code cycle, position sensing that is based on carrier-phase measurements may be more precise than position sensing based on code-phase measurements. For example, if the delay t_{TOF} can be determined using the carrier wave, then the positioning signal receiver 300 may be able to sense position with precision on the order of tens of centimeters.

The carrier wave received at the antenna 330 may be denoted C_{R}(t) and may be delayed with respect to the carrier wave C_{T}(t) transmitted by the transmitting device, such that C_{R}(t)=C_{T}(t−t_{TOF}). Because the timing and frequency of the transmitted carrier wave C_{T}(t) are predetermined and/or known to the positioning signal receiver 300, and because the receiver clock 350 is synchronized with an analogous transmitter clock incorporated in the transmitting device, the positioning signal receiver 300 may be configured to replicate the transmitted carrier wave C_{T}(t), and thereby measure a phase difference φ between the transmitted carrier wave C_{T}(t) and the received carrier wave C_{R}(t). The phase difference φ may be measured in cycles and may be referred to as a fractional carrier phase measurement.

However, the carrier wave may have a repeating pattern with a period T_{CW}, and the delay t_{TOF} may be significantly greater than the period T_{CW}. Accordingly, the delay t_{TOF} may not be determinable based solely on the measured phase difference φ. In particular, because the delay t_{TOF} may be greater than the period T_{CW}, the phase difference φ may only constitute a fraction of the delay t_{TOF}. The remainder of the delay t_{TOF} may consist of a plurality of full cycles of the repeating carrier wave. Accordingly, the delay t_{TOF} may include the measured phase difference φ and an unknown integer number of full cycles of the carrier wave. The unknown integer number of full cycles may be referred to as an integer ambiguity and may be denoted M. Accordingly, a precise estimate of the delay t_{TOF} can be determined based on the equation t_{TOF}=T_{CW}*(M+4)), where T_{CW} is predetermined and known, and φ can be measured. However, the integer ambiguity M must be resolved before the delay t_{TOF} can be determined.

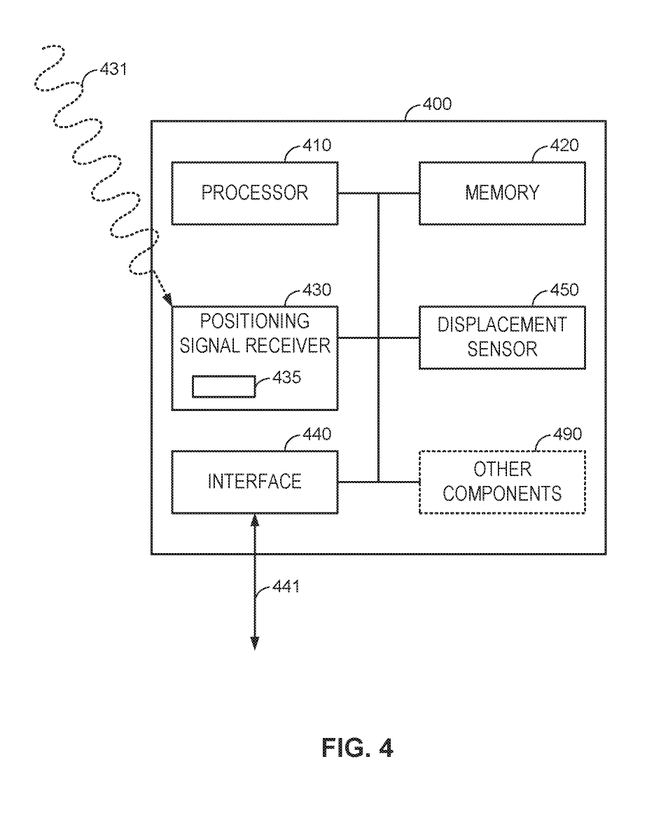

FIG. 4 generally illustrates a mobile device 400 in accordance with aspects of the disclosure. The mobile device 400 may be analogous in some respects to the mobile device 200 depicted in FIG. 2. For example, the mobile device 400 may include a processor 410 and a memory 420 analogous to the processor 210 and the memory 220, respectively, a positioning signal receiver 430 and an interface 440 analogous to the positioning signal receiver 230 and the interface 240, respectively, and other components 490 analogous to the other components 290. The positioning signal receiver 430 may be configured to receive one or more positioning signals 431 analogous to the one or more positioning signals 231, and the interface 440 may be configured to exchange interface data 441 analogous to the interface data 241. Although the aforementioned components of the mobile device 400 may be analogous in some respects, it will be understood that the mobile device 400 provides several advantages relative to the mobile device 200, as will be discussed in greater detail below.

For example, unlike the mobile device 200, the mobile device 400 may further include a displacement sensor 450 configured to generate spatial-based displacement data. The spatial-based displacement data may indicate a relative change in a position of the displacement sensor 450 over time, for example, from a first portion of a period of time to a second portion of the period of time subsequent to the first portion of the period of time. The displacement sensor 450 may include any suitable sensor for sensing displacement. For example, the displacement sensor 450 may comprise a visual-inertial odometry sensor, one or more cameras, one or more LIDAR sensors, one or more accelerometers, one or more gyroscopes, one or more compasses, or any combination thereof. One or more of the accelerometers, gyroscopes, and/or compasses may be incorporated in an inertial measurement unit (IMU).

The positioning signal receiver 430 may comprise a receiver clock 435. The receiver clock 435 may be analogous to the receiver clock 350 depicted in FIG. 3. The positioning signal receiver 430 may be configured to receive positioning signals 431 analogous to the positioning signals 331 depicted in FIG. 3. The positioning signals 431 may be received from a transmitting device analogous to, for example, one or more of the transmitting devices 120, 130, 140 depicted in FIG. 1. The positioning signals 431 may be received over a period of time.

The positioning signal receiver 430 may be further configured to estimate range measurements to the transmitting device based on the positioning signals 431. Each of the range measurements to the transmitting device estimated by the positioning signal receiver 430 may include a code-phase measurement associated with the transmitting device and a carrier-phase measurement associated with the transmitting device. The positioning signal receiver 430 may be further configured to lock a carrier tracking loop to track a carrier phase of at least one of the transmitting devices. The positioning signal receiver 430 may be further configured to lock another carrier tracking loop to track another carrier phase of any other transmitting device, for example, the transmitting device 130 or any other transmitting device analogous to the transmitting devices 120, 130, 140.

It will be understood that the positioning signals 431 may be transmitted from a plurality of transmitting devices, and that the positioning signal receiver 430 may be configured to independently track the signals received from each of the plurality of transmitting devices. For example, the positioning signal receiver 430 may be further configured to receive other positioning signals corresponding to the period of time from one or more other transmitting devices. The one or more other transmitting devices may be analogous to one or more of the transmitting devices 120, 130, 140 depicted in FIG. 1. The positioning signal receiver 430 may estimate range measurements to the other transmitting devices based on the other positioning signals.

The processor 410 and/or memory 420 may be further configured to calculate a change in a receiver clock bias of the receiver clock 435. The calculated change in the receiver clock bias may correspond to a particular period of time. The calculating may be based, at least in part, on the range measurements estimated by the positioning signal receiver 430. Additionally or alternatively, the calculating may be based, at least in part, on the spatial-based displacement data generated by the displacement sensor 450. In particular, the calculating may be based on spatial-based displacement data corresponding to the particular period of time.

The processor 410 and/or memory 420 may be further configured to propagate a first range measurement. The first range measurement may be estimated by the positioning signal receiver 430 and may correspond to a first portion of a particular period of time. The propagating may include propagating the first range measurement to correspond to a second portion of the period of time wherein the first portion of the period of time occurred prior to the second portion of the period of time. For example, the first range measurement may be a past range measurement estimated at a previous epoch and may be propagated forward to a subsequent epoch, for example, a present epoch. The propagating may be based, at least in part, on the spatial-based displacement data generated by the displacement sensor 450. Additionally or alternatively, the propagating may be based, at least in part, on the change in the receiver clock bias calculated by the processor 410 and/or memory 420.

The processor 410 and/or memory 420 may be further configured to determine an outlier range measurement based, at least in part, on the first range measurement propagated at 540. Additionally or alternatively, the determining of the outlier range measurement may be based, at least in part, on a second range measurement corresponding to the second portion of the period of time. The second range measurement may be estimated by the positioning signal receiver 430. As noted above, the second portion of the period of time may be the portion of the period of time to which the first range measurement was propagated by the processor 410 and/or memory 420. For example, the second time period may be a present epoch and the first range measurement may be a past range measurement estimated at a previous epoch and propagated forward to the present epoch.

The processor 410 and/or memory 420 may be further configured to identify the outlier range measurement from among a second range measurement corresponding to a second portion of the period of time and other second range measurements corresponding to the second portion of the period of time. The processor 410 and/or memory 420 may be further configured to discard the outlier range measurement and use one or more remaining second range measurements from among the second range measurement and the other second range measurements to determine a position of the mobile device 400.

For example, the second portion of the period of time may be a present epoch. Moreover, the positioning signal receiver 430 may be configured to receive positioning signals 431 from a plurality of transmitting devices during the present epoch, for example, the transmitting devices 120, 130, 140 depicted in FIG. 1. Of the distinct positioning signals received from the transmitting devices 120, 130, 140, one or more range measurements, for example, the range measurement associated with the transmitting device 140, may be identified as the outlier range measurement and discarded. The remaining range measurements, from the transmitting devices 120, 130 in this example, may be used to determine a position of the mobile device 400.

In the description of FIG. 4, and in the remainder of the present disclosure, one or more operations may be described as being performed by the processor 410 and/or memory 420. Although the singular is used, it will be understood that “processor” may refer to one or more processors without departing from the scope of the present disclosure. Moreover, “memory” may refer to one or more units of memory without departing from the scope of the present disclosure. Accordingly, any function or operation of the mobile device 400 that is described in the present disclosure as being performed by processor 410 and/or memory 420 may be performed, without departing from the scope of the present disclosure, by any number of processors and/or any number of memories. For example, the functions or operation of the mobile device 400 described in the present disclosure may be performed by the processor 410 and/or the memory 420, a processor and/or memory associated with the positioning signal receiver 430, a processor and/or memory associated with another component of the mobile device 400, or by any combination thereof.

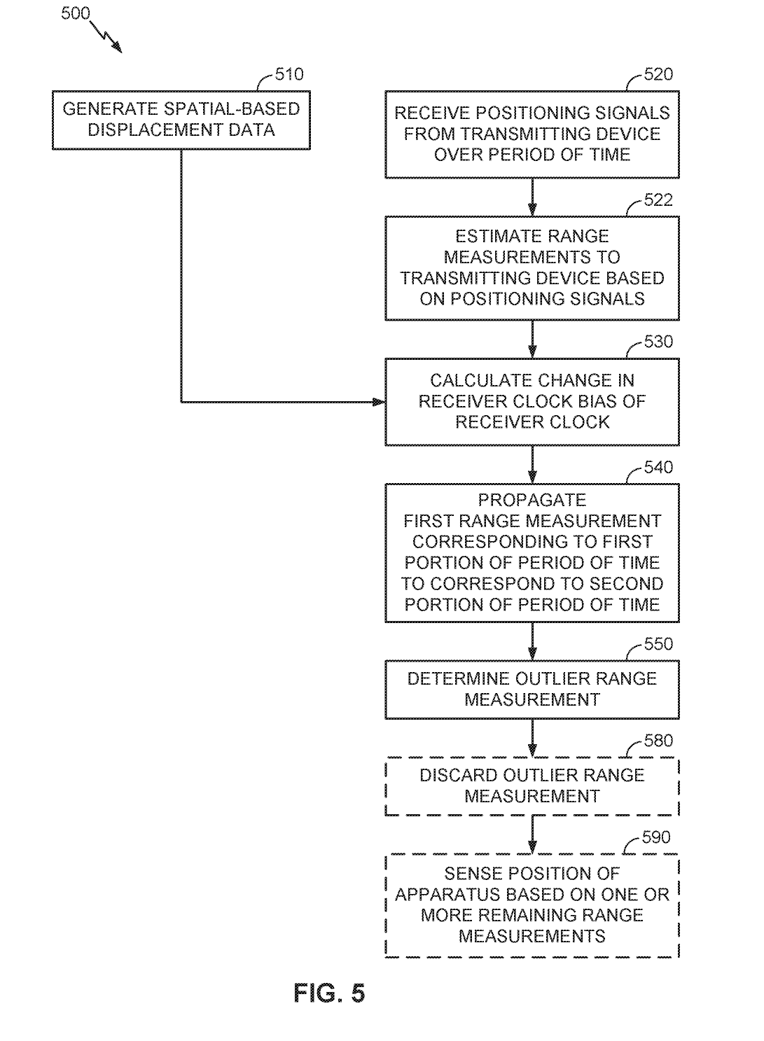

FIG. 5 generally illustrates a method 500 for use in position sensing in accordance with aspects of the disclosure. The method 500 will be described as it would be performed by, for example, the mobile device 400 depicted in FIG. 4.

At 510, the mobile device 400 generates spatial-based displacement data. The generating at 510 may be performed over a period of time, for example, from a past epoch to a present epoch. The generating at 510 may be performed by, for example, the displacement sensor 450 depicted in FIG. 4. Accordingly, it will be understood that the displacement sensor 450 may constitute means for generating spatial-based displacement data.

At 520, the mobile device 400 receives positioning signals 431 from a transmitting device over a period of time. The period of time may include a first portion, for example, a past epoch, and a second portion, for example, a present epoch. The receiving at 520 may be performed by, for example, the positioning signal receiver 430 depicted in FIG. 4. Accordingly, it will be understood that the positioning signal receiver 430 may constitute means for receiving positioning signals from a transmitting device over a period of time and estimating range measurements to the transmitting device based on the positioning signals.

At 522, the mobile device 400 estimates range measurements to the transmitting device based on the positioning signals received at 520. The estimating at 522 may be performed by, for example, the positioning signal receiver 430 depicted in FIG. 4. Accordingly, it will be understood that the positioning signal receiver 430 may constitute means for receiving positioning signals from a transmitting device over a period of time and estimating range measurements to the transmitting device based on the positioning signals.

In some implementations, the estimating at 522 includes estimating a code-phase measurement associated with the transmitting device based on the positioning signals received at 520 and estimating a carrier-phase measurement associated with the transmitting device based on the positioning signals received at 520. Accordingly, it will be understood that the positioning signal receiver 430 may constitute means for estimating a code-phase measurement associated with the transmitting device and means for estimating a carrier-phase measurement associated with the transmitting device.

At 530, the mobile device 400 calculates a change in a receiver clock bias of a receiver clock, for example, the receiver clock 435, based on the range measurements estimated at 522 and the spatial-based displacement data generated at 510. The calculating at 530 may be performed by, for example, the processor 410 and/or memory 420. Accordingly, it will be understood that the processor 410 and/or memory 420 may constitute means for calculating a change in a receiver clock bias of a receiver clock based on the range measurements and the spatial-based displacement data corresponding to the period of time.

At 540, the mobile device 400 propagates a first range measurement corresponding to a first portion of the period of time to correspond to a second portion of the period of time based, at least in part, on the spatial-based displacement data generated at 510 and the change in the receiver clock bias calculated at 530, wherein the first portion of the period of time occurred prior to the second portion of the period of time. The propagating at 540 may be performed by, for example, the processor 410 and/or memory 420. Accordingly, it will be understood that the processor 410 and/or memory 420 may constitute means for propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time.

At 550, the mobile device 400 determines an outlier range measurement based, at least in part, on the propagated first range measurement propagated at 540 and a second range measurement corresponding to the second portion of the period of time estimated at 522. The determining at 550 may be performed by, for example, the processor 410 and/or memory 420. Accordingly, it will be understood that the processor 410 and/or memory 420 may constitute means for determining an outlier range measurement based, at least in part, on the propagated first range measurement and a second range measurement corresponding to the second portion of the period of time.

At 580, the mobile device 400 optionally discards the outlier range measurement determined at 550. The discarding at 580 may be performed by, for example, the processor 410 and/or memory 420. Accordingly, it will be understood that the processor 410 and/or memory 420 may constitute means for discarding the outlier range measurement.

It will be understood that in some implementations, the receiving at 520 may optionally include receiving a plurality of positioning signals from a plurality of transmitting devices over the period of time, and that the estimating at 522 may corresponding include estimating a plurality of range measurements based on the plurality of positioning signals, the plurality of positioning signals received from the plurality of transmitting devices including the positioning signals received from the transmitting device. Moreover, the determining at 550 may include identifying the outlier range measurement from among the plurality of range measurements. Accordingly, the positioning signal receiver 430 may constitute means for receiving a plurality of positioning signals from a plurality of transmitting devices over the period of time and estimating a plurality of range measurements based on the plurality of positioning signals, means for receiving the plurality of positioning signals from the plurality of transmitting devices including the means for receiving positioning signals from the transmitting device. Moreover, the processor 410 and/or memory 420 may constitute means for identifying the outlier range measurement from among the plurality of range measurements.

At 590, the mobile device 400 optionally senses a position of the mobile device 400 based on one or more remaining range measurements from among a plurality of range measurements estimated at 522, wherein the one or more remaining range measurements do not include the discarded outlier range measurement that is discarded at 580. The sensing at 590 may be performed by, for example, the processor 410 and/or memory 420. Accordingly, it will be understood that the processor 410 and/or memory 420 may constitute means for sensing a position of the apparatus based on one or more remaining range measurements from among the plurality of range measurements, wherein the one or more remaining range measurements do not include the discarded outlier range measurement.

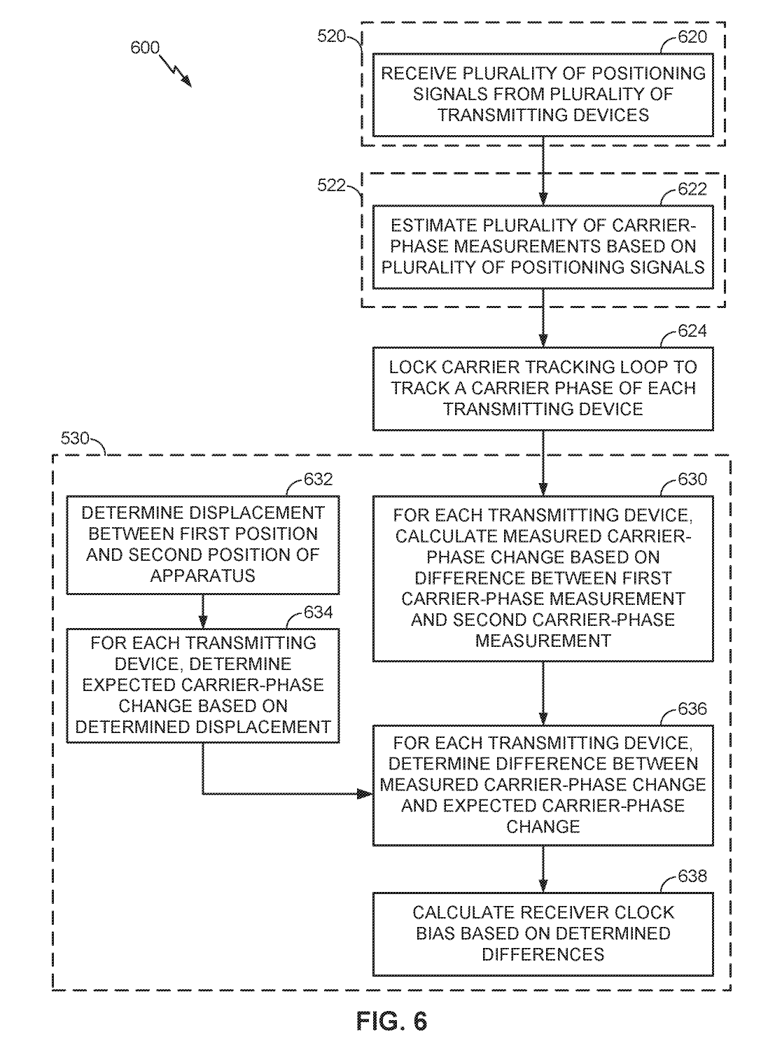

FIG. 6 generally illustrates a method 600 for calculating a change in a receiver clock bias of a receiver clock. The method 600 will be described as it would be performed by, for example, the mobile device 400 depicted in FIG. 4, and may be performed in order to determine a change in the receiver clock bias of the receiver clock 435. As noted above, the method 500 comprises at 530 calculating a change in a receiver clock bias of a receiver clock. As will be discussed in greater detail below, the method 600 may be a particular implementation of one or more of the actions described above in relation to FIG. 5.

At 620, the mobile device 400 receives a plurality of positioning signals from the plurality of transmitting devices. At 622, the mobile device 400 estimates a plurality of carrier-phase measurements based on the plurality of positioning signals received at 620. The receiving at 620 may be analogous in some respects to the receiving at 520 depicted in FIG. 5. The estimating at 622 may be analogous in some respects to the estimating at 522 depicted in FIG. 5.

As noted above with respect to FIG. 5, the positioning signal receiver 430 of the mobile device 400 may, at 520, receive positioning signals 431 from a particular transmitting device over a period of time, and, at 522, estimate range measurements to the transmitting device based on the positioning signals received at 520. It will be understood that the positioning signal received from a particular transmitting device may be one of a plurality of positioning signals received from a plurality of transmitting devices. As a result, the mobile device 400 may, at 620 and 622, receive positioning signals and estimate range measurements for each of the transmitting devices 120, 130, 140 depicted in FIG. 1. As noted above, each range measurement may include a code-phase measurement and a carrier-phase measurement.

At 624, the mobile device 400 locks a carrier tracking loop to track a carrier phase of each of, for example, the transmitting devices 120, 130. As an example based on the scenario depicted in FIG. 1, the mobile device 400 may lock a first carrier tracking loop associated with the transmitting device 120 and a second carrier tracking loop associated with the transmitting device 130. The mobile device 400 may attempt and fail to lock a third carrier tracking loop associated with the transmitting device 140 because, for example, the positioning signal 141 associated with the transmitting device 140 is blocked and/or reflected (as depicted in FIG. 1). As a result, any carrier-phase measurement associated with the transmitting device 140 may be removed from the processing from this point forward in the method 600.

Returning briefly to FIG. 5, it will be understood that the calculating at 530 is based on spatial-based displacement data generated at 510 and range measurements estimated at 522. The remaining operations 630-638 may be performed as a particular implementation of the calculating at 530 depicted in FIG. 5.

At 630, the mobile device 400 calculates, for each transmitting device, a measured carrier-phase change based on a difference between a first carrier-phase measurement from the first portion of the period of time and a second carrier-phase measurement from the second portion of the period of time. It will be understood that the calculating at 630 may be performed on the basis of the range measurements estimated at 622. The calculating at 630 may be performed by, for example, the processor 410 and/or memory 420. Accordingly, it will be understood that the processor 410 and/or memory 420 may constitute means for calculating a measured carrier-phase change associated with a transmitting device based on a difference between a first carrier-phase measurement from a first portion of a period of time and a second carrier-phase measurement from a second portion of the period of time.

As noted above, the first portion of the period of time may be a past epoch and the second portion of the period of time may be a present epoch. Accordingly, the mobile device 400 may estimate the first carrier-phase measurement during the past epoch and the second carrier-phase measurement during the present epoch.

At 632, the mobile device 400 determines a displacement, based on spatial-based displacement data, between a first position of the mobile device 400 at a first portion of a period of time and a second position of the apparatus at a second portion of the period of time, the second portion of the period of time being subsequent to the first portion of the period of time. It will be understood that the spatial-based displacement data may be analogous to the spatial-based displacement data generated at 510 of FIG. 5. The determining at 632 may be performed by, for example, the processor 410 and/or memory 420 and may use the spatial-based displacement data generated at 510. Accordingly, it will be understood that the processor 410 and/or memory 420 may constitute means for determining a displacement, based on spatial-based displacement data, between a first position of an apparatus at a first portion of a period of time and a second position of the apparatus at a second portion of the period of time.

In some implementations, the first portion of the period of time may be a past epoch and the second portion of the period of time may be a present epoch. Accordingly, the mobile device 400 may determine at 632 a displacement of the mobile device 400 from a past position (in a past epoch) to a present position (in a present epoch). The displacement data may include a relative direction and a relative distance of the mobile device 400 based on motion between the past epoch and the present epoch.

At 634, the mobile device 400 determines an expected carrier-phase measurement change based on the displacement determined at 632. The determining at 634 may be individually performed for each transmitting device of a plurality of transmitting devices. The determining at 634 may be performed by, for example, the processor 410 and/or memory 420. Accordingly, it will be understood that the processor 410 and/or memory 420 may constitute means for determining an expected carrier-phase change from the first portion of the period of time to the second portion of the period of time based on the determined displacement.

In some implementations, a past carrier-phase measurement associated with a particular transmitting device, for example, the transmitting device 120 depicted in FIG. 1, may have been measured by the mobile device 400. It will be understood that based on the known position of the transmitting device 120 and a particular carrier-phase measurement associated with the transmitting device 120, a displacement of the mobile device 400 may have a predictable effect on a future carrier-phase measurement. Accordingly, the mobile device 400 may obtain a past carrier-phase measurement and determine, based on actual displacement data from the past to the present, what the expected carrier-phase measurement should be. As noted above, the expected carrier-phase measurement may be determined for the transmitting devices 130, 140, etc., as well as the transmitting device 120.

At 636, the mobile device 400 determines, for each transmitting device, a difference between the measured carrier-phase change calculated at 630 and the expected carrier-phase change determined at 634. The difference determined at 636 may be referred to as an adjusted differenced carrier phase. At 638, the mobile device 400 calculates a change in the receiver clock bias of the receiver clock 435 based on the differences determined at 636, for example, a plurality of differences associated with each of the transmitting devices, respectively. If the locking of the carrier tracking loop at 624 can only be performed with respect to one transmitting device, for example, the transmitting device 120, then the difference associated with the transmitting device 120 may be used by itself to calculate the change in the receiver clock bias of the receiver clock 435, for example, the calculated change in the receiver clock bias may be equal to the difference determined at 636. If there are a plurality of locks associated with a plurality of transmitting devices 120, 130, etc., then an average or median of the adjusted differenced carrier phases (for example, a first estimate associated with a first transmitting device and a second estimate associated with a second transmitting device) may be used to calculate the change in the receiver clock bias, for example, the calculated change in the receiver clock bias may be equal to the average or median of the differences determined at 636. The determining at 636 and the calculating at 638 may be performed by, for example, the processor 610 and/or memory 620. Accordingly, it will be understood that the processor 610 and/or memory 420 may constitute means for calculating a change in receiver clock bias based on a difference between a measured carrier-phase change and an expected carrier-phase change.

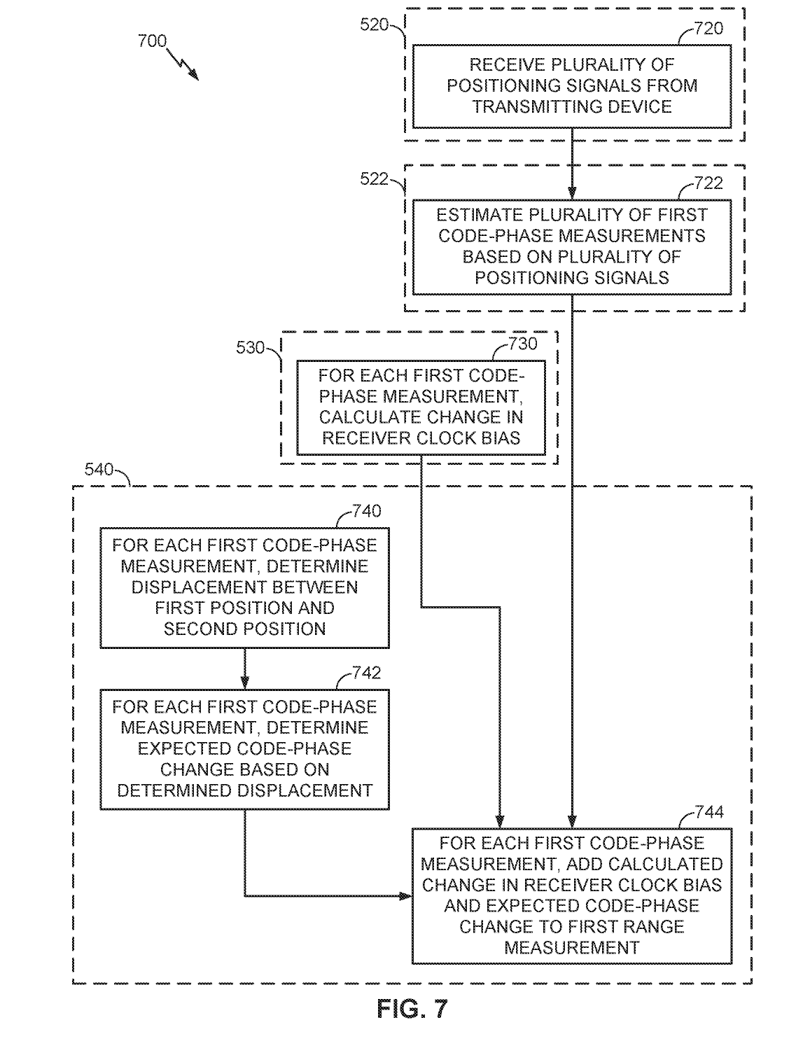

FIG. 7 generally illustrates a method 700 for propagating range measurements, for example, for propagating a plurality of first range measurements associated with a plurality of first portions of a period of time to correspond to a second portion of the period of time in accordance with aspects of the disclosure. The method 700 will be described as it would be performed by, for example, the mobile device 400 depicted in FIG. 4. As noted above, the method 500 comprises at 540 propagating a first range measurement corresponding to a first portion of the period of time to correspond to a second portion of the period of time. As will be discussed in greater detail below, the method 700 may be a particular implementation of one or more of the actions described above in relation to FIG. 5.

As noted above, a first portion of the period of time may be a past epoch and a second portion of the period of time may be a present epoch. Accordingly, the plurality of first range measurements referred to in the present description of FIG. 7 may be respectively associated with a plurality of past epochs. Moreover, the plurality of past epochs may occur prior to the present epoch associated with a second range measurement. For example, if a present epoch is denoted present epoch [k], then the plurality of past epochs may respectively be denoted past epoch [k−1], past epoch [k−2], past epoch [k−3], etc. As will be understood from the discussion that follows, a greater number of propagations of a greater number of first range measurements may result in more reliable outlier detection.

The method 700 will be described below as it would be performed with respect to the transmitting device 120. However, it will be understood that the method 700 may be replicated for each of a plurality of transmitting devices, for example, the transmitting devices 120, 130, etc.

At 720, the mobile device 400 receives a plurality of positioning signals from the transmitting device 120. At 722, the mobile device 400 estimates a plurality of first code-phase measurements based on the plurality of positioning signals received at 720. The receiving at 720 may be analogous in some respects to the receiving at 520 depicted in FIG. 5. The estimating at 722 may be analogous in some respects to the estimating at 522 depicted in FIG. 5. In some implementations, the plurality of positioning signals may be received over a plurality of epochs, and the mobile device 400 may estimate a plurality of first code-phase measurement respectively associated with each epoch.

At 730, the mobile device 400 calculates, for each first code-phase measurement of the plurality of first code-phase measurements, a change in receiver clock bias. The calculating at 730 may be analogous to the calculating at 530 described above with respect to FIG. 5. It will be understood that the calculating at 730 may be analogous in some respects to the method 600 depicted in FIG. 6. It will be further understood that the change in receiver clock bias may be different for each of the first code-phase measurements. For example, a calculated change in receiver clock bias from past epoch [k−3] to present epoch [k] may differ from a calculated change in receiver clock bias from past epoch [k−2] to present epoch [k]. Accordingly, the method 700 may calculate a respective change in receiver clock bias for each of the plurality of first code-phase measurements.

At 740, the mobile device 400 determines, for each first code-phase measurement of the plurality of first code-phase measurements, a displacement between a first position of the mobile device 400 at a first portion of a period of time and a second position of the apparatus at a second portion of the period of time, the second portion of the period of time being subsequent to the first portion of the period of time. It will be understood that the determining at 740 may be based on spatial-based displacement data analogous to the spatial-based displacement data generated at 510. The determining at 740 may be performed by, for example, the processor 410 and/or memory 420 and may use the spatial-based displacement data generated at 510. Accordingly, it will be understood that the processor 410 and/or memory 420 may constitute means for determining a displacement, based on the spatial-based displacement data, between a first position of the apparatus at the first portion of the period of time and a second position of the apparatus at the second portion of the period of time.

As noted above, the first portion of the period of time may be a past epoch and the second portion of the period of time may be a present epoch. Accordingly, the mobile device 400 may determine at 740 a displacement of the mobile device 400 from a past position (in a past epoch) to a present position (in a present epoch). The displacement data may include a relative direction and a relative distance of the mobile device 400 based on motion between the past epoch and the present epoch. Similar to the change in receiver clock bias, the displacement determination at 740 may be different for each of the first code-phase measurements. For example, a determination of displacement from past epoch [k−3] to present epoch [k] may differ from a determination of displacement from past epoch [k−2] to present epoch [k]. Accordingly, the method 700 may determine a respective displacement for each of the plurality of first code-phase measurements.

At 742, the mobile device 400 determines an expected code-phase measurement change based on the displacement determined at 740. The determining at 742 may be individually performed for each first code-phase measurement of the plurality of first code-phase measurements. The determining at 742 may be performed by, for example, the processor 410 and/or memory 420. Accordingly, it will be understood that the processor 410 and/or memory 420 may constitute means for determining an expected code-phase change from the first portion of the period of time to the second portion of the period of time based on the spatial-based displacement data.

In some implementations, a past code-phase measurement associated with a particular transmitting device, for example, the transmitting device 120, and a particular past epoch, for example, the past epoch [k−3], may have been measured by the mobile device 400. It will be understood that based on the known position of the transmitting device 120 and the particular code-phase measurement associated with the past epoch [k−3], a displacement of the mobile device 400 from past epoch [k−3] to the present epoch [k] may have a predictable effect on code-phase measurements. Accordingly, the mobile device 400 may obtain a past code-phase measurement and determine, based on actual displacement data from the past to the present, what the expected code-phase measurement should be. As noted above, the expected code-phase measurement may be determined for each past epoch [k−3], [k−2], etc.

At 744, the mobile device 400 adds the calculated change in receiver clock bias and the expected code-phase change to each first range measurement of the plurality of first range measurements. The result of the adding at 744 may be a plurality of propagated first range measurements. As noted above, both the calculated change in receiver clock bias and the expected code-phase change may vary among the plurality of first range measurements. Accordingly, the adding may be performed separately for each of the plurality of first range measurements. The adding at 744 may be performed by, for example, the processor 410 and/or memory 420. Accordingly, it will be understood that the processor 410 and/or memory 420 may constitute means for determining a propagated code-phase measurement by adding a calculated change in receiver clock bias and an expected code-phase change to a first range measurement.

As an example, given a first range measurement associated with past epoch [k−3], the method 700 may calculate a change in receiver clock bias based, at least in part, on a determined displacement from the past epoch [k−3] to the present epoch [k]. The method 700 may further determine an expected code-phase change based, at least in part, on the determined displacement from the past epoch [k−3] to the present epoch [k]. The method 700 may then propagate the first range measurement associated with the past epoch [k−3] to correspond to the present epoch [k]. The method 700 may be repeated for first range measurements associated with the past epochs [k−2], [k−1], etc. Accordingly, each of a plurality of first range measurements associated with past epochs may be propagated forward to, for example, a present epoch using the method 700.

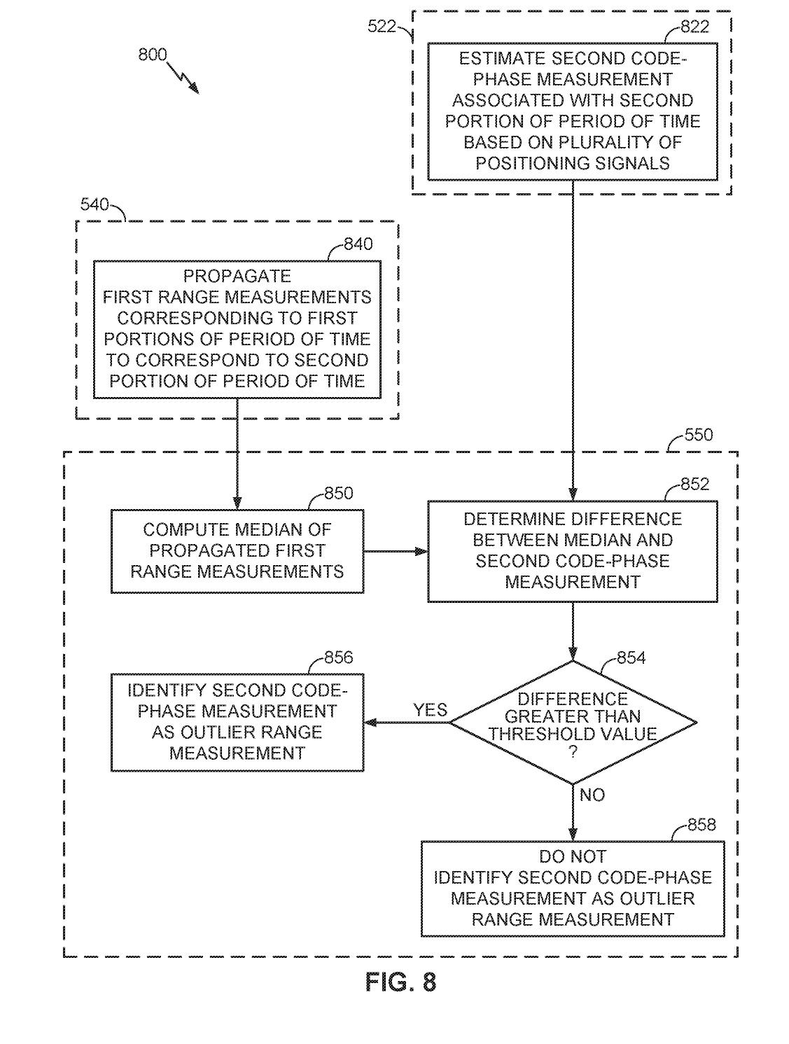

FIG. 8 generally illustrates a method 800 for determining an outlier range measurement in accordance with aspects of the disclosure. The method 800 will be described as it would be performed by, for example, the mobile device 400 depicted in FIG. 4. As noted above, the method 500 comprises at 550 determining of an outlier range measurement. As will be discussed in greater detail below, the method 800 may be a particular implementation of one or more of the actions described above in relation to FIG. 5.

At 822, the mobile device 400 estimates a second code-phase measurement associated with a second portion of a period of time based on a plurality of positioning signals. The estimating at 822 may be analogous in some respects to the estimating at 522 depicted in FIG. 5 and may be based on a plurality of positioning signals analogous to the plurality of positioning signals received at 520.

At 840, the mobile device 400 propagates a plurality of first range measurements corresponding to a plurality of first portions of the period of time to correspond to a second portion of the period of time. The propagating at 840 may be analogous in some respects to the propagating at 540 depicted in FIG. 5. It will be further understood that the propagating at 840 may be analogous in some respects to the method 700 depicted in FIG. 7.

As noted above, the plurality of first portions of the period of time may be past epochs and the second portion of the period of time may be a present epoch. Accordingly, the plurality of first range measurements propagated at 840 may correspond to past epochs [k−3], [k−2], etc., and the second code-phase measurement estimated at 822 may be estimated during the present epoch [k].

At 850, the mobile device 400 computes a median of the propagated first range measurements propagated at 840. The computing at 850 may be performed by, for example, the processor 410 and/or memory 420.

At 852, the mobile device 400 determines a difference between the median computed at 850 and the second code-phase measurement estimated at 822. The determining at 852 may include determining an absolute value of the difference. The determining at 852 may be performed by, for example, the processor 410 and/or memory 420. Accordingly, it will be understood that the processor 410 and/or memory 420 may constitute means for determining a difference between a propagated first range measurement and a second range measurement.

At 854, the mobile device 400 compares the difference determined at 852 to a threshold value. The comparing at 854 may be performed by, for example, the processor 410 and/or memory 420. Accordingly, it will be understood that the processor 410 and/or memory 420 may constitute means for comparing a difference to a threshold value.

In response to a determination at 852 that the difference is greater than the threshold value (‘yes’ at 854), then the method 800 may proceed to 856. At 856, the method 800 identifies the second code-phase measurement as an outlier range measurement. As noted above with respect to FIG. 5, the mobile device 400 may discard the second code-phase measurement based on a determination (such as the determination at 856) that the second code-phase measurement is an outlier range measurement. Accordingly, the mobile device 400 may sense position without using the second code-phase measurement which has been identified as an outlier range measurement.

However, if the difference determined at 852 is not greater than the threshold value (‘no’ at 854), then the method 800 may proceed to 858. At 858, the method 800 does not identify the second code-phase measurement as an outlier range measurement. If the method 800 does not identify the second code-phase measurement as an outlier range measurement (as at 858), then the mobile device 400 may determine that the second code-phase measurement may be used for position sensing.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. An apparatus for use in position sensing, the apparatus comprising:
a displacement sensor configured to generate spatial-based displacement data;
a positioning signal receiver comprising a receiver clock and configured to receive positioning signals from a transmitting device over a period of time and estimate range measurements to the transmitting device based on the positioning signals;
memory; and
a processor coupled to the displacement sensor, the positioning signal receiver, and the memory, wherein processor and memory are configured to:
calculate a change in a receiver clock bias of the receiver clock based on the range measurements and the spatial-based displacement data corresponding to the period of time;
propagate a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time; and
determine an outlier range measurement based, at least in part, on the propagated first range measurement and a second range measurement corresponding to the second portion of the period of time.

2. The apparatus of claim 1, wherein:
the positioning signal receiver is further configured to:
receive a plurality of positioning signals from a plurality of transmitting devices over the period of time and estimate a plurality of range measurements based on the plurality of positioning signals; and
the memory and processor are further configured to:
identify the outlier range measurement from among the plurality of range measurements;
discard the outlier range measurement; and
sense a position of the apparatus based on one or more remaining range measurements from among the plurality of range measurements, wherein the one or more remaining range measurements do not include the discarded outlier range measurement.

3. The apparatus of claim 1, wherein the spatial-based displacement data indicates a relative change in a position of the apparatus from the first portion of the period of time to the second portion of the period of time.

4. The apparatus of claim 1, wherein the displacement sensor comprises:
a visual-inertial odometry sensor;
one or more cameras;
one or more LIDAR sensors;
one or more accelerometers;
one or more gyroscopes;
one or more compasses; or
any combination thereof.

5. The apparatus of claim 1, wherein the range measurements to the transmitting device estimated by the positioning signal receiver each include a code-phase measurement associated with the transmitting device and a carrier-phase measurement associated with the transmitting device.

6. The apparatus of claim 5, wherein to calculate the change in the receiver clock bias, the memory and processor are further configured to:
calculate a measured carrier-phase change associated with the transmitting device based on a difference between a first carrier-phase measurement from the first portion of the period of time and a second carrier-phase measurement from the second portion of the period of time;
determine a displacement, based on the spatial-based displacement data, between a first position of the apparatus at the first portion of the period of time and a second position of the apparatus at the second portion of the period of time; and
determine an expected carrier-phase change from the first portion of the period of time to the second portion of the period of time based on the determined displacement;
wherein the change in the receiver clock bias is calculated based on a difference between the measured carrier-phase change and the expected carrier-phase change.

7. The apparatus of claim 6, wherein:
the positioning signal receiver is further configured to lock a carrier tracking loop to track a carrier phase of the transmitting device; and
the memory and processor are further configured to:
determine, based on the locking, that the transmitting device is a locked transmitting device; and
use carrier-phase measurements associated with the locked transmitting device to calculate the change in the receiver clock bias based on the determination that the transmitting device is a locked transmitting device.

8. The apparatus of claim 6, wherein:
the positioning signal receiver is further configured to receive a plurality of positioning signals from a plurality of transmitting devices over the period of time and estimate a plurality of range measurements based on the plurality of positioning signals; and
the memory and processor are further configured to:
generate a first estimate of the change in the receiver clock bias based on carrier-phase measurements associated with a first transmitting device of the plurality of transmitting devices; and
generate a second estimate of the change in the receiver clock bias based on carrier-phase measurements associated with a second transmitting device of the plurality of transmitting devices;
wherein the change in the receiver clock bias is calculated based on a median of the first estimate and the second estimate.

9. The apparatus of claim 5, wherein to propagate the first range measurement to correspond to the second portion of the period of time, the memory and processor are further configured to:
determine a displacement, based on the spatial-based displacement data, between a first position of the apparatus at the first portion of the period of time and a second position of the apparatus at the second portion of the period of time;
determine an expected code-phase change from the first portion of the period of time to the second portion of the period of time based on the spatial-based displacement data; and
determine a propagated code-phase measurement by adding the calculated change in receiver clock bias and the expected code-phase change to the first range measurement.

10. The apparatus of claim 1, wherein to determine the outlier range measurement, the memory and processor are further configured to:
compare the propagated first range measurement to the second range measurement corresponding to the second portion of the period of time;
determine a difference between the propagated first range measurement and the second range measurement;
compare the difference to a threshold value; and
identify the second range measurement as the outlier range measurement in response to a determination that the difference is greater than the threshold value.

11. A method for use in position sensing, the method comprising:
generating spatial-based displacement data;
receiving positioning signals from a transmitting device over a period of time and estimating range measurements to the transmitting device based on the positioning signals;
calculating a change in a receiver clock bias of a receiver clock based on the range measurements and the spatial-based displacement data corresponding to the period of time;
propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time; and
determining an outlier range measurement based, at least in part, on the propagated first range measurement and a second range measurement corresponding to the second portion of the period of time.

12. The method of claim 11, further comprising:
receiving a plurality of positioning signals from a plurality of transmitting devices over the period of time and estimating a plurality of range measurements based on the plurality of positioning signals, the plurality of positioning signals received from the plurality of transmitting devices including the positioning signals received from the transmitting device;
identifying the outlier range measurement from among the plurality of range measurements;
discarding the outlier range measurement; and
sensing a position of an apparatus based on one or more remaining range measurements from among the plurality of range measurements, wherein the one or more remaining range measurements do not include the discarded outlier range measurement.

13. The method of claim 11, wherein the spatial-based displacement data indicates a relative change in a position of the apparatus from the first portion of the period of time to the second portion of the period of time.

14. The method of claim 11, wherein to generate the spatial-based displacement data, the method uses a displacement sensor comprising:
a visual-inertial odometry sensor;
one or more cameras;
one or more LIDAR sensors;
one or more accelerometers;
one or more gyroscopes;
one or more compasses; or
any combination thereof.

15. The method of claim 11, wherein estimating the range measurements to the transmitting device includes estimating a code-phase measurement associated with the transmitting device and estimating a carrier-phase measurement associated with the transmitting device.

16. The method of claim 15, wherein the calculating of the change in the receiver clock bias comprises:
calculating a measured carrier-phase change associated with the transmitting device based on a difference between a first carrier-phase measurement from the first portion of the period of time and a second carrier-phase measurement from the second portion of the period of time;
determining a displacement, based on the spatial-based displacement data, between a first position of the apparatus at the first portion of the period of time and a second position of the apparatus at the second portion of the period of time; and
determining an expected carrier-phase change from the first portion of the period of time to the second portion of the period of time based on the determined displacement;
wherein the change in the receiver clock bias is calculated based on a difference between the measured carrier-phase change and the expected carrier-phase change.

17. The method of claim 16, further comprising:
locking a carrier tracking loop to track a carrier phase of the transmitting device; and
using carrier-phase measurements associated with the locked transmitting device to calculate the change in the receiver clock bias based on the determination that the transmitting device is a locked transmitting device.

18. The method of claim 16, further comprising:
receiving a plurality of positioning signals from a plurality of transmitting devices over the period of time and estimating a plurality of range measurements based on the plurality of positioning signals, the plurality of positioning signals received from the plurality of transmitting devices including the positioning signals received from the transmitting device;
generating a first estimate of the change in the receiver clock bias based on carrier-phase measurements associated with a first transmitting device of the plurality of transmitting devices;
generating a second estimate of the change in the receiver clock bias based on carrier-phase measurements associated with a second transmitting device of the plurality of transmitting devices;
wherein the change in the receiver clock bias is calculated based on a median of the first estimate and the second estimate.

19. The method of claim 15, wherein the propagating of the first range measurement comprises:
determining a displacement, based on the spatial-based displacement data, between a first position of the apparatus at the first portion of the period of time and a second position of the apparatus at the second portion of the period of time;
determining an expected code-phase change from the first portion of the period of time to the second portion of the period of time based on the spatial-based displacement data; and
determining a propagated code-phase measurement by adding the calculated change in receiver clock bias and the expected code-phase change to the first range measurement.

20. The method of claim 11, wherein determining the outlier range measurement comprises:
comparing the propagated first range measurement to the second range measurement corresponding to the second portion of the period of time;
determining a difference between the propagated first range measurement and the second range measurement;
comparing the difference to a threshold value; and
identifying the second range measurement as the outlier range measurement in response to a determination that the difference is greater than the threshold value.

21. An apparatus for use in position sensing, the apparatus comprising:
means for generating spatial-based displacement data;
means for receiving positioning signals from a transmitting device over a period of time and estimating range measurements to the transmitting device based on the positioning signals;
means for calculating a change in a receiver clock bias of a receiver clock based on the range measurements and the spatial-based displacement data corresponding to the period of time;
means for propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time; and
means for determining an outlier range measurement based, at least in part, on the propagated first range measurement and a second range measurement corresponding to the second portion of the period of time.

22. The apparatus of claim 21, further comprising:
means for receiving a plurality of positioning signals from a plurality of transmitting devices over the period of time and estimating a plurality of range measurements based on the plurality of positioning signals, means for receiving the plurality of positioning signals from the plurality of transmitting devices including the means for receiving positioning signals from the transmitting device;
means for identifying the outlier range measurement from among the plurality of range measurements;
means for discarding the outlier range measurement; and
means for sensing a position of the apparatus based on one or more remaining range measurements from among the plurality of range measurements, wherein the one or more remaining range measurements do not include the discarded outlier range measurement.

23. The apparatus of claim 21, wherein means for estimating the range measurements to the transmitting device includes means for estimating a code-phase measurement associated with the transmitting device and means for estimating a carrier-phase measurement associated with the transmitting device.

24. The apparatus of claim 23, wherein means for calculating of the change in the receiver clock bias comprises:
means for calculating a measured carrier-phase change associated with the transmitting device based on a difference between a first carrier-phase measurement from the first portion of the period of time and a second carrier-phase measurement from the second portion of the period of time;
means for determining a displacement, based on the spatial-based displacement data, between a first position of the apparatus at the first portion of the period of time and a second position of the apparatus at the second portion of the period of time; and
means for determining an expected carrier-phase change from the first portion of the period of time to the second portion of the period of time based on the determined displacement;
wherein means for calculating the change in the receiver clock bias includes means for calculating the change in the receiver clock bias based on a difference between the measured carrier-phase change and the expected carrier-phase change.

25. The apparatus of claim 5, means for propagating of the first range measurement comprising:
means for determining a displacement, based on the spatial-based displacement data, between a first position of the apparatus at the first portion of the period of time and a second position of the apparatus at the second portion of the period of time;
means for determining an expected code-phase change from the first portion of the period of time to the second portion of the period of time based on the spatial-based displacement data; and
means for determining a propagated code-phase measurement by adding the calculated change in receiver clock bias and the expected code-phase change to the first range measurement.

26. A non-transitory computer-readable medium including code, which, when executed by a processor, causes the processor to perform operations, the computer-readable medium comprising:
code for generating spatial-based displacement data;
code for receiving positioning signals from a transmitting device over a period of time and estimating range measurements to the transmitting device based on the positioning signals;
code for calculating a change in a receiver clock bias of a receiver clock based on the range measurements and the spatial-based displacement data corresponding to the period of time;
code for propagating a first range measurement corresponding to a first portion of the period of time to correspond to a second portion of the period of time based, at least in part, on the spatial-based displacement data and the change in the receiver clock bias, wherein the first portion of the period of time occurred prior to the second portion of the period of time; and
code for determining an outlier range measurement based, at least in part, on the propagated first range measurement and a second range measurement corresponding to the second portion of the period of time.

27. The non-transitory computer-readable medium of claim 26, further comprising:
code for receiving a plurality of positioning signals from a plurality of transmitting devices over the period of time and estimating a plurality of range measurements based on the plurality of positioning signals, code for receiving the plurality of positioning signals from the plurality of transmitting devices including the code for receiving positioning signals from the transmitting device;
code for identifying the outlier range measurement from among the plurality of range measurements;
code for discarding the outlier range measurement; and
code for sensing a position of the apparatus based on one or more remaining range measurements from among the plurality of range measurements, wherein the one or more remaining range measurements do not include the discarded outlier range measurement.

28. The non-transitory computer-readable medium of claim 26, wherein code for estimating the range measurements to the transmitting device includes code for estimating a code-phase measurement associated with the transmitting device and code for estimating a carrier-phase measurement associated with the transmitting device.

29. The non-transitory computer-readable medium of claim 28, wherein code for calculating of the change in the receiver clock bias comprises:
code for calculating a measured carrier-phase change associated with the transmitting device based on a difference between a first carrier-phase measurement from the first portion of the period of time and a second carrier-phase measurement from the second portion of the period of time;
code for determining a displacement, based on the spatial-based displacement data, between a first position of the apparatus at the first portion of the period of time and a second position of the apparatus at the second portion of the period of time; and
code for determining an expected carrier-phase change from the first portion of the period of time to the second portion of the period of time based on the determined displacement;
wherein code for calculating the change in the receiver clock bias includes code for calculating the change in the receiver clock bias based on a difference between the measured carrier-phase change and the expected carrier-phase change.

30. The non-transitory computer-readable medium of claim 26, code for propagating of the first range measurement comprising:
code for determining a displacement, based on the spatial-based displacement data, between a first position of the apparatus at the first portion of the period of time and a second position of the apparatus at the second portion of the period of time;
code for determining an expected code-phase change from the first portion of the period of time to the second portion of the period of time based on the spatial-based displacement data; and
code for determining a propagated code-phase measurement by adding the calculated change in receiver clock bias and the expected code-phase change to the first range measurement.
